(19) United States
(12) Patent Application Publication
(10) Pub. No.: US 2015/0042637 A1
(43) Pub. Date: Feb. 12, 2015

(54) SOURCE DRIVER AND OPERATION METHOD THEREOF

(71) Applicant: Novatek Microelectronics Corp., Hsinchu (TW)

(72) Inventors: Li-Tang Lin, Hsinchu City (TW); Chia-Hung Lin, Hsinchu City (TW); Pei-Ye Wang, Taipei City (TW)

(73) Assignee: Novatek Microelectronics Corp., Hsinchu (TW)

(21) Appl. No.: 14/033,520

(22) Filed: Sep. 23, 2013

(30) Foreign Application Priority Data
Aug. 12, 2013 (TW) 102128850

(51) Int. Cl. G09G 5/00

(52) U.S. Cl. CPC G09G 5/008
USPC 345/213

(57) ABSTRACT

A source driver and an operation method thereof are provided. The operation method includes following steps. A data signal is provided to the source driver. The operating current of the source driver is reduced to an abnormal operating level in period from the source driver is reset to before a pixel data of the source driver is appeared in the data signal. The operation current of the source driver is restored to a normal operating level when the pixel data of the source driver is appeared in the data signal.

### CROSS-REFERENCE TO RELATED APPLICATION

This application claims the priority benefit of Taiwan application serial no. 102128850, filed on Aug. 12, 2013. The entirety of the above-mentioned patent application is hereby incorporated by reference herein and made a part of this specification.

### BACKGROUND OF THE INVENTION

1. Field of the Invention

The invention relates to an operation method of an electronic device, and more particularly to a source driver and an operation method thereof.

2. Description of Related Art

Generally, when a conventional source driver (SD) transmits a data signal, in order to synchronize the data signal to be received, each source driver continues to receive a clock signal provided by a system, and generates a clock signal for synchronizing with each other, so as to avoid the source driver from missing or mistakenly taking data.

FIG. 1 is a schematic diagram of operations in a conventional source driver. As shown in FIG. 1, it is supposed that source drivers #1, #2, #3, #4 and #5 are provided in a display device. A reset signal RES represents a timing in which the source drivers #1, #2, #3, #4 and #5 are simultaneously reset. Since the source drivers #1, #2, #3, #4 and #5 are simultaneously reset, the clock signals in the source drivers #1, #2, #3, #4 and #5 can be synchronized with each other. It is required for the synchronized clock signals generated after each of the source drivers are reset to at least be maintained until a data signal DATA is received. However, it can be known from FIG. 1 that, at a time interval T1, only the source driver #1 has received the data signal DATA while maintaining synchronizing of the timing, whereas the source drivers #2 to #5 without receiving the data signal DATA but still maintains synchronizing of the timing by using a normal operating level; at a time interval T2, only the source driver #2 has received the data signal DATA while maintaining synchronizing of the timing, whereas the source drivers #3 to #5 without receiving the data signal DATA but still maintains synchronizing of the timing by using a normal operating level (the rest may be deduced by analogy, thus further description is omitted hereinafter). Accordingly, it is found that as the source drivers at a further back position of rear-stage in the display device (e.g., the source drivers #2, #3, #4 and #5), as time passed by, said source drivers simply use a current at the normal operating level to maintain synchronizing of the clock signals during the time period without the data signal being received, which costs extra power consumption for the display device.

### SUMMARY OF THE INVENTION

The invention provides a source driver and an operation thereof, capable of effectively reducing power consumption caused by maintaining synchronizing of clock signals when data signal is not yet received by the source driver.

The invention provides an operation method of a source driver, which includes: providing a data signal to a source driver; reducing an operating current of the source driver to an abnormal operating level in period from the source driver is reset to before a pixel data of the source driver is appeared in the data signal; and restoring the operation current of the source driver to a normal operating level when the pixel data of the source driver is appeared in the data signal.

The invention provides a source driver including a receiving interface circuit, a core circuit and a current source control circuit. The receiving interface circuit is configured to receive a data signal and a clock signal from outside of the source driver and output an internal clock corresponding to the clock signal. The core circuit is coupled to the receiving interface circuit, and configured to drive a display panel outside of the source driver by using a pixel data of the source driver appeared in the data signal according to a timing of the internal clock. The current source control circuit is coupled to the receiving interface circuit, and configured to supply an operating current to the receiving interface circuit. The current source control circuit reduces the operating current of the receiving interface circuit to an abnormal operating level in period from the source driver is reset to before the pixel data of the source driver is appeared in the data signal. The current control circuit restores the operation current of the receiving interface circuit to a normal operating level when the pixel data of the source driver is appeared in the data signal.

In an embodiment of the invention, the step of reducing the operating current of the source driver includes: reducing an operating current of a receiving interface circuit of the source driver to the abnormal operating level in period from the source driver is reset to before the pixel data of the source driver is appeared in the data signal.

In an embodiment of the invention, the step of reducing the operating current of the source driver includes: reducing an operating current of a frequency divider of the source driver to the abnormal operating level in period from the source driver is reset to before the pixel data of the source driver is appeared in the data signal.

In an embodiment of the invention, the step of reducing the operating current of the source driver to the abnormal operating level includes: providing a clock signal to the source driver, in which a clock receiver and at least one data receiver of the source driver receive the clock signal and the data signal, respectively; reducing an operating current of the clock receiver to the abnormal operating level in period from the source driver is reset to before an initial impulse is generated by an initial signal transmitted to the source driver, so as to maintain synchronizing of the clock signal in the source driver, in which a timing of the initial impulse is in respond to a timing in which the pixel data of the source driver is appeared in the data signal; and suspending power supply to the data receiver in period from the source driver is reset to before the initial impulse is generated by the initial signal.

In an embodiment of the invention, the step of restoring the operating current of the source driver to the normal operating level includes: resuming power supply to the data receiver after the initial impulse is generated by the initial signal.

An embodiment of the invention further includes: providing a clock signal to the source driver, in which a clock receiver of the source driver receives the clock signal, and provides an internal clock corresponding to the clock signal to a core circuit of the source driver through a clock transmission path; turning off the clock transmission path to stop providing the internal clock to the core circuit in period from the source driver is reset to before the pixel data of the source driver is appeared in the data signal; and restoring the clock transmission path when the pixel data of the source driver is appeared in the data signal.

In an embodiment of the invention, the step of reducing the operating current of the source driver to the abnormal operating level includes: providing a clock signal to the source driver, in which a receiving interface circuit of the source driver receives the clock signal and the data signal, and provides an internal clock corresponding to the clock signal to a core circuit of the source driver through a clock transmission path; reducing the operating current of the receiving interface circuit to the abnormal operating level in period from the source driver is reset to before a first initial impulse is generated by the initial signal transmitted to the source driver; and turning off the clock transmission path, in which a timing of the first initial impulse is in response to a timing in which the pixel data of the source driver is appeared in the data signal.

An embodiment of the invention further includes: restoring the operating current of the receiving interface circuit to the normal operating level, and continuing to turn off the clock transmission path, in period from the first initial impulse is generated by the initial signal to before a second initial impulse is generated by the initial signal; and maintaining the operating current of the receiving interface circuit to the normal operating level, and restoring the clock transmission path, after the second initial impulse is generated by the initial signal.

An embodiment of the invention further includes: reducing the operating current of the source driver to the abnormal operating level again after the pixel data of the source driver appeared in the data signal is transmitted.

An embodiment of the invention further includes: starting a time counting after the source driver is reset, so as to determine a timing in which the pixel data of the source driver is appeared in the data signal.

In an embodiment of the invention, the receiving interface circuit includes a clock receiver and at least one data receiver. The clock receiver is configured to receive the clock signal and output the internal clock corresponding to the clock signal to the core circuit. The at least one data receiver is configured to receive the data signal and provide the data signal to the core circuit. Therein, the current source control circuit reduces an operating current of the clock receiver to the abnormal operating level and suspends power supply to the data receiver in period from the source driver is reset to before the pixel data of the source driver is appeared in the data signal. The current source control circuit restores the operating current of the clock receiver to the normal operating level and resumes power supply to the data receiver when the pixel data of the source driver is appeared in the data signal.

In an embodiment of the invention, the clock receiver includes a receiver and a frequency divider. The receiver configured to receive the clock signal. The frequency divider is coupled to an output terminal of the receiver, and configured to convert an output of the receiver into the internal clock and output the internal clock to the core circuit. The current source control circuit reduces the operating current of the frequency divider to an abnormal operating level in period from the source driver is reset to before the pixel data of the source driver is appeared in the data signal. The current control circuit restores the operation currents of the receiver and the frequency divider to a normal operating level when the pixel data of the source driver is appeared in the data signal.

In an embodiment of the invention, the current source control circuit receives an initial signal from outside of the source driver. The current source control circuit reduces the operating current of the receiving interface circuit to the abnormal operating level, in period from the source driver is reset to before an initial impulse is generated by the initial signal, in which a timing of the initial impulse is in respond to a timing in which the pixel data of the source driver is appeared in the data signal. The current source control circuit resumes power supply to the receiving interface circuit after the initial impulse is generated by the initial signal.

In an embodiment of the invention, the receiving interface circuit provides the internal clock to the core circuit through a clock transmission path, and the source driver further includes a switch disposed on the clock transmission path and coupled between the receiving interface circuit and the core circuit. The switch turns off the clock transmission path to stop providing the internal clock to the core circuit in period from the source driver is reset to before the pixel data of the source driver is appeared in the data signal. The switch restores the clock transmission path when the pixel data of the source driver is appeared in the data signal.

In an embodiment of the invention, the receiving interface circuit provides the internal clock to the core circuit through the clock transmission path. The current source control circuit receives an initial signal from outside of the source driver. The source driver further includes a switch disposed on the clock transmission path, and coupled between the receiving interface circuit and the core circuit. The current source control circuit reduces the operating current of the receiving interface circuit to the abnormal operating level in period from the source driver is reset to before a first initial impulse is generated by the initial signal. The switch turns off the clock transmission path. A timing of the first initial impulse is in response to a timing in which the pixel data of the source driver is appeared in the data signal. The current source control circuit restores the operating current of the receiving interface circuit to the normal operating level, and the switch continues to turn off the clock transmission path, in period from the first initial impulse is generated by the initial signal to before a second initial impulse is generated by the initial signal. The current source control circuit maintains the operating current of the receiving interface circuit to the normal operating level, and the switch restores the clock transmission path, after the second initial impulse is generated by the initial signal.

In an embodiment of the invention, the current source control circuit reduces the operating current of the source driver to the abnormal operating level again after the pixel data of the source driver appeared in the data signal is transmitted.

In an embodiment of the invention, a counter is further included, the counter is coupled to the current source control circuit, and configured to start a time counting after the source driver is reset, and provide a timing result to the current source control circuit, in which the current source control circuit determines a timing in which the pixel data of the source driver is appeared in the data signal according to the timing result.

In summary, the source driver and the operation method thereof provided by the invention controls the currents or the clock transmission path of the source driver not receiving the data by using a digital control. As a result, when each source driver is not receiving the data, only a few current is required to maintain synchronizing of the clock signals, so as to reduce the power consumption of the source driver in overall applications.

To make the above features and advantages of the disclosure more comprehensible, several embodiments accompanied with drawings are described in detail as follows.

### BRIEF DESCRIPTION OF THE DRAWINGS

FIG. 1 is a schematic diagram of a conventional source driver.

FIG. 2 is a block diagram illustrating a source driver according to an embodiment of the invention.

FIG. 3 is a block diagram illustrating a current source control circuit depicted in FIG. 2 according to an embodiment of the invention.

FIG. 4 is a block diagram illustrating a current source control circuit depicted in FIG. 2 according to another embodiment of the invention.

FIG. 5 is a flow chart illustrating an operation method of the source driver depicted in FIG. 2 according to first embodiment of the invention.

FIG. 6 is a flow chart illustrating an operation method of the source driver depicted in FIG. 2 according to second embodiment of the invention.

FIG. 7 is a flow chart illustrating an operation method of the source driver depicted in FIG. 2 according to third embodiment of the invention.

FIG. 8 is a flow chart illustrating an operation method of the source driver depicted in FIG. 2 according to fourth embodiment of the invention.

FIG. 9 is a flow chart illustrating an operation method of the source driver depicted in FIG. 2 according to fifth embodiment of the invention.

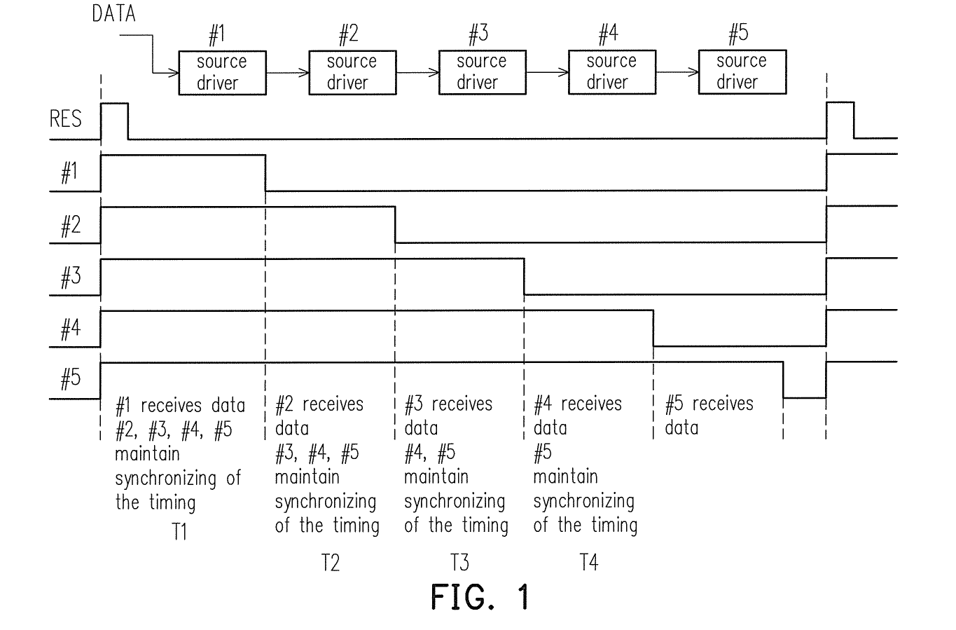

### DESCRIPTION OF THE EMBODIMENTS

Descriptions of the invention are given with reference to the exemplary embodiments illustrated with accompanied drawings, in which same or similar parts are denoted with same reference numerals. Moreover, elements/components/notations with same reference numerals represent same or similar parts in the drawings and embodiments.

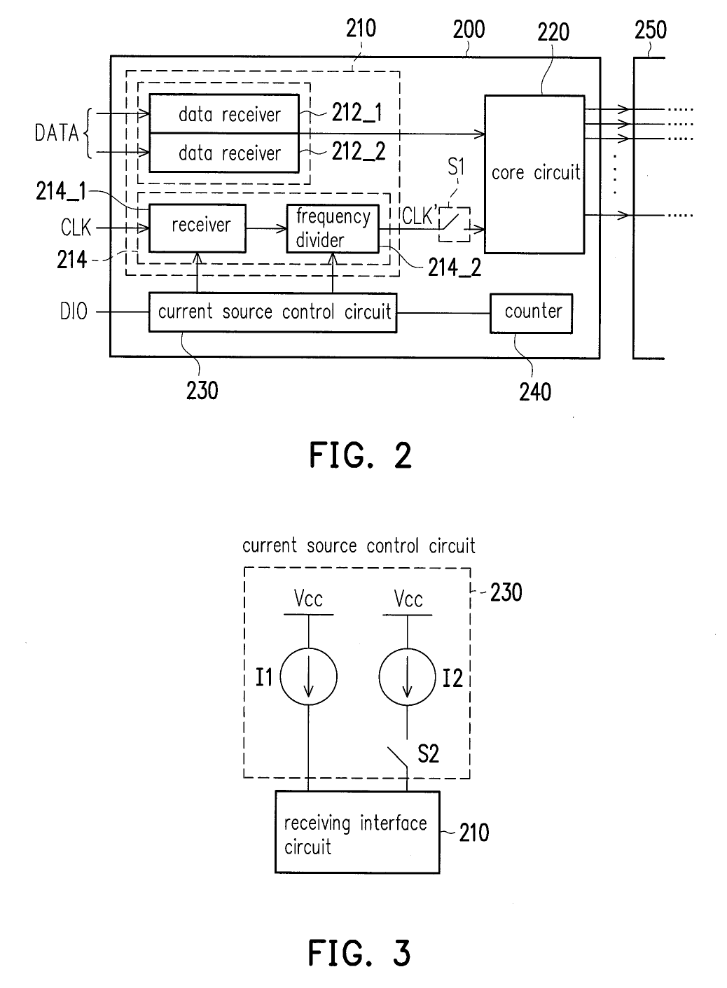

FIG. 2 is a block diagram illustrating a source driver 200 according to an embodiment of the invention. Referring to FIG. 2, the source driver 200 of the present embodiment is adapted to a display device (not illustrated), and configured to drive a display panel 250 outside of the source driver 200. In the present embodiment, the display device (not illustrated) can include one or more source drivers. For the clarity and simplicity, it is described by illustrating only one source driver 200 as an example, but the invention is not limited thereto.

The source driver 200 includes a receiving interface circuit 210, a core circuit 220 and a current source control circuit 230. The receiving interface circuit 210 is configured to receive a data signal DATA and a clock signal CLK from outside of the source driver 200 and output an internal clock CLK′ corresponding to the clock signal CLK through a clock transmission path. Therein, the clock transmission path is a path between the receiving interface circuit 210 and the core circuit 220 and configured to transmit the internal clock CLK′, as shown in FIG. 2. The receiving interface circuit 210 can receive the data signal DATA and the clock signal CLK from a front-stage circuit outside of the source driver 200, such as a timing controller (TCON, not illustrated), but the invention is not limited thereto.

The core circuit 220 is coupled to the receiving interface circuit 210, and configured to receive the internal clock CLK′ and the data signal DATA and drive a display panel 250 outside of the source driver 200 by using a pixel data of the source driver 200 appeared in the data signal DATA according to a timing of the internal clock CLK′.

The current source control circuit 230 is coupled to the receiving interface circuit 210, and configured to supply an operating current to the receiving interface circuit 210. It should be noted that, after the source driver 200 is reset, the current source control circuit 230 can reduce the operating current of the source driver 200 to an abnormal operating level. For instance, the operating currents of the receiving internal circuit 210 and/or other internal circuits are reduced until the pixel data of the source driver 200 is appeared in the data signal DATA. When the pixel data of the source driver 200 is appeared in the data signal DATA, the current control circuit 230 restores the operation current of the source driver 200 to a normal operating level. For instance, the operating currents of the receiving internal circuit 210 and/or other internal circuits are restored to the normal operating level.

In the present embodiment, mechanisms for the current source control circuit 230 to determine whether the pixel data of the source driver 200 is appeared in the data signal DATA are not particularly limited. The current source control circuit 230 can use any means to determine whether the pixel data of the source driver 200 is appeared in the data signal DATA. For instance, in the embodiment of FIG. 2, the current source control circuit 230 can determine whether the pixel data of the source driver 200 is appeared in the data signal DATA according to an initial signal DIO provided by the front-stage circuit (e.g., the timing controller or another source driver). More specifically, when an initial impulse is generated by the initial signal DIO received by the current source control circuit 230 in the source driver 200, this indicates that the pixel data of the source driver 200 is appeared in the data signal DATA, so that the current source control circuits 230 can then correspondingly restores the operating current of the source driver 200 to the normal operating level.

In the present embodiment, means for the current source control circuit 230 to adjust the operating current of the source driver 200 are not particularly limited. For instance, in some embodiments, the current source control circuit 230 can only reduce the operating current of the receiving interface circuit 210 to the abnormal operating level until the pixel data of the source driver 200 is appeared in the data signal DATA. For instance, in some other embodiments, the current source control circuit 230 can reduce the operating currents of the receiving interface circuit 210 and the core circuit 220 to the abnormal operating level until the pixel data of the source driver 200 is appeared in the data signal DATA. In other embodiments, the current source control circuit 230 can reduce the operating current of the receiving interface circuit 210 and stop providing the operating current to the core circuit 220 until the pixel data of the source driver 200 is appeared in the data signal DATA. On the other hand, means for the current source control circuit 230 to reduce the operating current of the source driver 200 to the abnormal operating level are not particularly limited in the present embodiment. For instance, FIG. 3 is a block diagram illustrating a current source control circuit 230 depicted in FIG. 2 according to an embodiment of the invention.

Referring to FIG. 2 and FIG. 3 together, in the present embodiment, the current source control circuit 230 includes two current sources I1, I2 and a switch S2. In the current source control circuit 230, the current source I1 is coupled between the receiving interface circuit 210 and a power voltage Vcc, and the current source I2 and the switch S2 are connected in series between the power voltage Vcc and the receiving interface circuit 210. By operating the switch S2, the current source control circuit 230 can select the current source I1 for supplying the operating current to the receiving interface circuit 210, or select the current source I1 and current source I2 together for supplying the operating current to the receiving interface circuit 210. Accordingly, the current source control circuit 230 can control the operating current of the source driver 200 to switch from the normal operating level to the abnormal operating level, or from the abnormal operating level to the normal operating level. Amounts and the coupling relations of the current sources I1, I2 and the switch S2 can be adjusted/modified based on actual requirements, and the invention is not limited thereto.

The implementation of the current source control circuit 230 is not particularly limited by the present embodiment. For instance, FIG. 4 is a block diagram illustrating a current source control circuit depicted in FIG. 2 according to another embodiment of the invention. In the embodiment of FIG. 4, the current source control circuit 230 includes two current sources I3, I4 which are coupled between the receiving interface circuit 210 and a ground potential GND, and a current source I4 and a switch S3 which are connected in series between the ground potential GND and the receiving interface circuit 210. By operating the switch S3, the current source control circuit 230 can select the current source I3 for supplying the operating current to the receiving interface circuit 210, or select the current source I3 and current source I4 together for supplying the operating current to the receiving interface circuit 210. Accordingly, the current source control circuit 230 can control the operating current of the source driver 200 to switch from the normal operating level to the abnormal operating level, or from the abnormal operating level to the normal operating level. Amounts and the coupling relations of the current sources I3, I4 and the switch S3 can be adjusted/modified based on actual requirements, and the invention is not limited thereto. Besides, in other embodiments, the current source control circuit 230 is further implemented by a variable current source.

Referring back FIG. 2, the receiving interface circuit 210 further includes at least one data receiver (e.g., data receivers 212_1 and 212_2 depicted in FIG. 2) and a clock receiver 214, which are configured to receive the data signal DATA and the clock signal CLK provided by the front-stage circuit, respectively. Therein, for the clarity and simplicity, the data receiver in the receiving interface circuit 210 is described by illustrating only two data receivers 212_1 and 212_2 as an example, but the invention is not limited thereto. The data receivers 212_1 and 212_2 receive the data signal DATA and provide the data signal DATA to the core circuit 220. The clock receiver 214 receives the clock signal CLK and outputs the internal clock CLK′ corresponding to the clock signal CLK to the core circuit 220. The current source control circuit 230 reduces an operating current of the clock receiver 214 to the abnormal operating level and suspends power supply to the data receivers 212_1 and 212_2 in period from the source driver 200 is reset to before the pixel data of the source driver 200 is appeared in the data signal DATA. The current source control circuit 230 restores the operating current of the clock receiver 214 to the normal operating level and resumes power supply to the data receivers 212_1 and 212_2 when the pixel data of the source driver 200 is appeared in the data signal DATA.

The implementation of the clock receiver 214 is not particularly limited by the present embodiment. For instance, the clock receiver 214 of the embodiment depicted in FIG. 2 includes a receiver 214_1 and a frequency divider 214_2. The receiver 214_1 is configured to receive the clock signal CLK provided by the front-stage circuit and output the clock signal CLK to the frequency divider 214_2. The frequency divider 214_2 is coupled to an output terminal of the receiver 214_1, and a frequency dividing calculation is performed to an output of the receiver 214_1 so as to convert the output of the receiver 214_1 into the internal clock CLK′ and output the internal clock CLK′ to the core circuit 220. The current source control circuit 230 can also reduce operating currents of the receiver 214_1 and the frequency divider 214_2 in the clock receiver 214 from the normal operating level to the abnormal operating level in period from the source driver 200 is reset to before the pixel data of the source driver 200 is appeared in the data signal DATA. The current source control circuit 230 can restore the operating currents of the receiver 214_1 and the frequency divider 214_2 from the abnormal operating level to the normal operating level when the pixel data of the source driver 200 is appeared in the data signal DATA.

On the other hand, in another embodiment, the source driver 200 can also be selectively disposed with a switch S1 on the clock transmission path. The switch S1 is coupled to the receiving interface circuit 210 and the core circuit 220. The receiving interface circuit 210 can provide the internal clock CLK′ to the core circuit 220 through the clock transmission path. The switch S1 can turn off the clock transmission path to stop providing the internal clock CLK′ to the core circuit 220 in period from the source driver 200 is reset to before the pixel data of the source driver 200 is appeared in the data signal DATA. The switch S1 can restore the clock transmission path when the pixel data of the source driver 200 is appeared in the data signal DATA, so as to resume providing the internal clock CLK′ to the core circuit 220.

In another embodiment, the source driver 200 can also be selectively disposed with a counter 240. The counter 240 is coupled to the current source control circuit 230. The counter 240 starts a time counting after the source driver 200 is reset, and provides a timing result to the current source control circuit 230. Generally, a time length from a time point in which the source driver 200 is reset, to a time point in which the pixel data of the source driver 200 is appeared in the data signal DATA, is predictable. Therefore, according to the timing result of the counter 240, the current source control circuit 230 can determine a timing (or the time point) in which the pixel of the source driver 200 is appeared in the data signal DATA. After the source driver 200 is reset, the current source control circuit 230 can reduce the operating current of the clock receiver 214 from the normal operating level to the abnormal operating level, and control the switch S1 to turn off the clock transmission path to stop providing the internal clock CLK′ to the core circuit 220. When the current source control circuit 230 determines that the pixel data of the source driver 200 is appeared in the data signal DATA according to the timing result of the counter 240, the current source control circuit 230 can restore the operating current of the source driver 200 to the normal operating level, and control the switch S1 to turn on the clock transmission path so as to resume providing the internal clock CLK′ to the core circuit 220.

In order to describe the operation method of the source driver 200 of the invention more clearly, detailed steps of the operation method of the source driver 200 are provided below with reference to various elements in the source driver 200 depicted in FIG. 2.

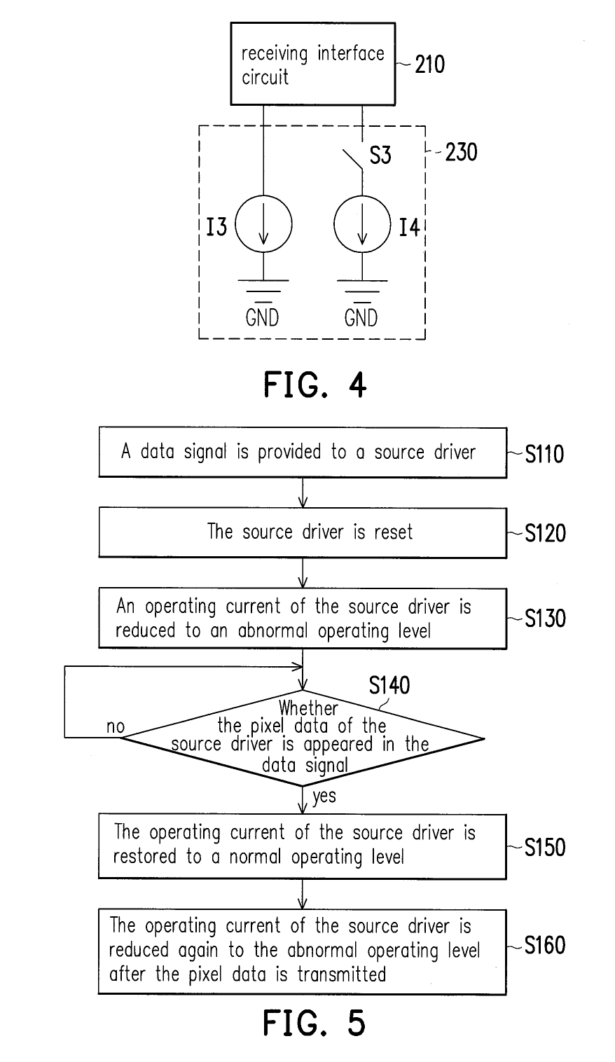

FIG. 5 is a flow chart illustrating an operation method of the source driver 200 depicted in FIG. 2 according to first embodiment of the invention. Referring to FIG. 2 and FIG. 5 together, first, the data signal DATA is provided to the simultaneously 200 in step S110. The data signal DATA can be provided by the front-stage circuit (e.g., the timing controller) outside of the source driver 200, but the invention is not limited thereto.

Next, the source driver 200 is reset in step S120. After the source driver 200 is reset, the current source control circuit 230 reduces the operating current of the receiving interface circuit 200 to the abnormal operating level (step S130) until the pixel data of the source driver 200 is appeared in the data signal DATA. For instance, in step S130 above, the current source control circuit 230 can reduce the operating current of the receiving interface circuit 210 in the source driver 200 to the abnormal operating level.

The current source control circuit 230 can determine whether the pixel data of the source driver 200 is appeared in the data signal DATA in step S140. When the pixel data of the source driver 200 is appeared in the data signal DATA, the current control circuit 230 restores the operation current of the source driver 200 to the normal operating level (step S150). For instance, in step S150 above, the current source control circuit 230 can restore the operating current of the receiving interface circuit 210 in the source driver 200 to the normal operating level.

In some embodiments, when the pixel data of the source driver 200 appeared in the data signal DATA is transmitted, the current control circuit 230 can reduce the operation current of the source driver 200 again to the abnormal operating level (step S160).

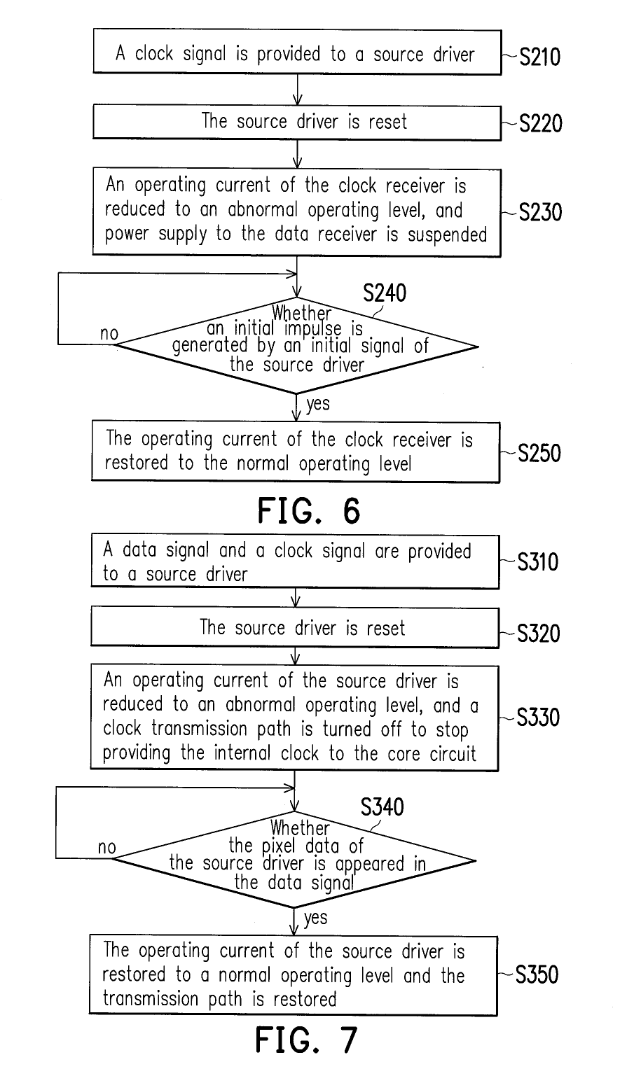

FIG. 6 is a flow chart illustrating an operation method of the source driver 200 depicted in FIG. 2 according to second embodiment of the invention. Therein, steps S210 and S220 depicted in FIG. 6 can refer related description of steps S110 and S120 depicted in FIG. 5, so it is omitted hereinafter.

Referring to FIG. 2 and FIG. 6 together, the front-stage circuit (e.g., the timing controller) provides the clock signal CLK and the data signal DATA to the source driver 200 in step S210. The data receivers 212_1 and 212_2 and the clock receiver 214 in the receiving interface circuit 210 of the source driver 200 receive the data signal DATA and the clock signal CLK, respectively. After the source driver 200 is reset (step S220), the current source control circuit 230 reduces the operating current of the clock receiver 214 in the receiving interface circuit 210 to the abnormal operating level and suspends power supply to the data receiver 212_1 and 212_2 in the receiving interface circuit 210 (step S230). For instance, the current source control circuit 230 can reduce the operating currents of receiver 214_1 and the frequency divider 214_2 in the clock receiver 214 to the abnormal operating level. Therein, the current having the abnormal operating level which is lower than the normal operating level can provide power to the clock receiver 214 so as to maintain a phase synchronization of the internal clock CLK′. In the present embodiment, the current source control circuit 230 can receive the initial signal DIO from the front-stage circuit (e.g., the timing controller or another source driver). A timing of the initial impulse of the initial signal DIO is in response (related to) to a timing in which the pixel data of the source driver 200 is appeared in the data signal DATA. When the initial impulse is generated by the initial signal DIO, this indicates that the pixel data of the source driver 200 is appeared in the data signal DATA, so that the current source control circuit 230 can provide power to the receiving interface circuit (step S150).

The current source control circuit 230 can determine whether the initial impulse is generated by the initial signal DIO in step S240. When the initial impulse is generated by the initial signal DIO received by the source driver 200, this indicates that the pixel data of the source driver 200 is about to be appeared in the data signal DATA, thus the current source control circuit 230 restores the operating current of the clock receiver 214 to the normal operating level and resumes power supply to the data receivers 212_1 and 212_2 (step S250).

FIG. 7 is a flow chart illustrating an operation method of the source driver depicted in FIG. 2 according to third embodiment of the invention. Therein, steps S310, S320 and S340 depicted in FIG. 7 can refer related description of steps S110, S120 and S140 depicted in FIG. 5, so it is omitted hereinafter. Referring to FIG. 2 and FIG. 7 together, the front-stage circuit provides the clock signal CLK and the data signal DATA to the source driver 200 in step S310. Therein, the clock receiver 214 of the source driver 200 receives the clock signal CLK, and provides an internal clock CLK′ corresponding to the clock signal CLK to the core circuit 220 of the source driver 200 through the clock transmission path. After the source driver 200 is reset (step S320), the current source control circuit 230 reduces the operating current of the clock receiver 200 to the abnormal operating level, and the switch S1 turns off the clock transmission path to stop providing the internal clock CLK′ to the core circuit 220 (step S330). The current source control circuit 230 can determine whether the pixel data of the source driver 200 is appeared in the data signal DATA in step S340. When the pixel data of the source driver 200 is appeared in the data signal DATA, the current source control circuit 230 restores the operating current of the source driver 200 to the normal operating level, and controls the switch S1 to restore the clock transmission path (step S350) so as to resume providing the internal clock CLK′ to the core circuit 220.

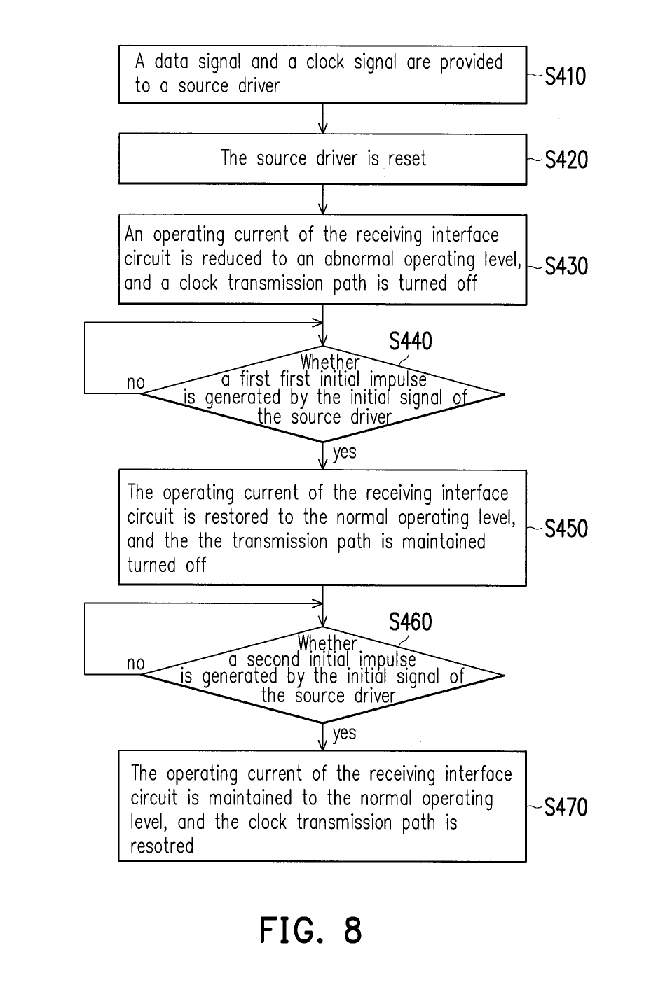

FIG. 8 is a flow chart illustrating an operation method of the source driver depicted in FIG. 2 according to fourth embodiment of the invention. Therein, steps S410 and S420 depicted in FIG. 8 can refer related description of steps S110 and S120 depicted in FIG. 5, so it is omitted hereinafter. Referring to FIG. 2 and FIG. 8 together, the front-stage circuit provides the clock signal CLK and the data signal DATA to the source driver 200 in step S410. Therein, the receiving interface circuit 210 of the source driver 200 receives the clock signal CLK and the data signal DATA, and provides an internal clock CLK′ corresponding to the clock signal CLK to the core circuit 220 of the source driver 200 through the clock transmission path. After the source driver 200 is reset (step S420), and before a first initial impulse is generated by the initial signal DIO received by the source driver 200, the current source control circuit 230 reduces the operating current of the receiving interface circuit 210 in the clock receiver 200 to the abnormal operating level, and the switch S1 turns off the clock transmission path (S430) to stop providing the internal clock CLK′ to the core circuit 220.

The current source control circuit 230 can determine whether the first initial impulse is generated by the initial signal DIO in step S440. Therein, a timing of the first initial impulse is in response (related to) to a timing in which the pixel data of the source driver 200 is appeared in the data signal DATA. The current source control circuit 230 restores the operating current of the receiving interface circuit 210 to the normal operating level, and the switch S1 continues to turn off the clock transmission path, in period from the first initial impulse is generated by the initial signal DIO in the source driver 200 to before a second initial impulse is generated by the initial signal DIO (step S450). The current source control circuit 230 can determine whether the second initial impulse is generated by the initial signal DIO in step S460. Therein, a timing of the second initial impulse is also in response (related to) to the timing in which the pixel data of the source driver 200 is appeared in the data signal DATA. When the second initial impulse is generated by the initial signal DIO in the source driver 200, the current source control circuit 230 maintains the operating current of the receiving interface circuit 210 in the clock receiver 200 to the normal operating level, and the switch S1 restores the clock transmission path (step S470) to provide the internal clock CLK′ again to the core circuit 220.

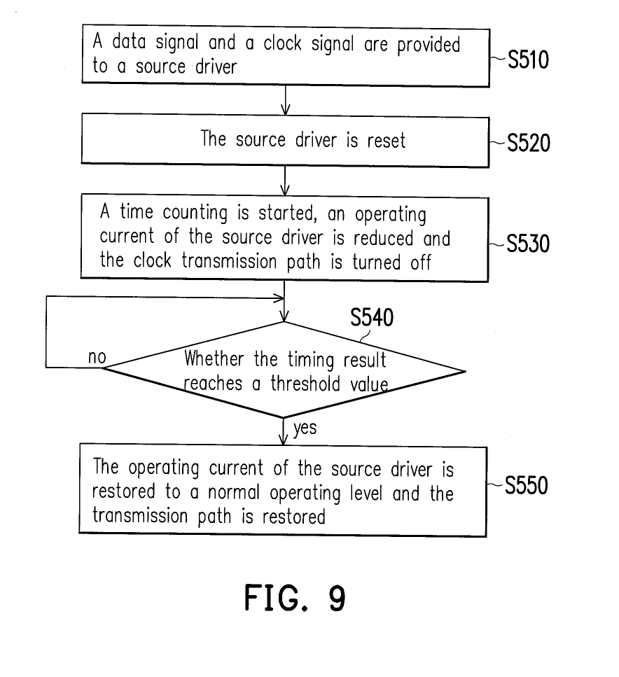

FIG. 9 is a flow chart illustrating an operation method of the source driver depicted in FIG. 2 according to fifth embodiment of the invention. Therein, steps S510 and S520 depicted in FIG. 9 can refer related description of steps S110 and S120 depicted in FIG. 5, so it is omitted hereinafter. Referring to FIG. 2 and FIG. 9 together, the front-stage circuit provides the clock signal CLK and the data signal DATA to the receiving interface circuit 210 of the source driver 200, and the receiving interface circuit 210 provides the internal clock CLK′ corresponding to the clock signal CLK to the core circuit 220 of the source driver 200 through the clock transmission path. After the source driver 200 is reset (step S520), the counter 240 in the source driver 200 starts a time counting and provides a timing result to the current source control circuit 230. The current source control circuit 230 reduces the operating current of the source driver 200 to the abnormal operating level in step S530, and controls the switch S1 to turn off the clock transmission path to stop providing the internal clock CLK′ to the core circuit 220. The current source control circuit 230 can determine whether the timing result of the counter 240 reaches a threshold value in step S540. In other words, according to the timing result of the counter 240, the current source control circuit 230 can determine a timing in which the pixel of the source driver 200 is appeared in the data signal DATA. When the timing result of the counter 240 reaches the threshold value, that is, the pixel data of the source driver 200 is appeared in the data signal DATA, the current source control circuit 230 restores the operating current of the source driver 200 to the normal operating level, and controls the switch S1 to restore the clock transmission path so as to provide the internal clock CLK′ again to the core circuit 220 (step S550).

In summary, the source driver and the operation method thereof provided by the invention controls the operating currents or the clock transmission path of the source driver 200 not receiving the data signal by using the current source control circuit 230 or the switch S1. As a result, when the source driver 200 is not receiving the data signal, only a few current is required to maintain synchronizing of the clock signals, so as to reduce the power consumption of the source driver 200 in overall applications.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An operation method of source driver, comprising:
providing a data signal to a source driver;
reducing an operating current of the source driver to an abnormal operating level in period from the source driver is reset to before a pixel data of the source driver is appeared in the data signal; and
restoring the operation current of the source driver to a normal operating level when the pixel data of the source driver is appeared in the data signal.

2. The operation method of claim 1, wherein reducing the operating current of the source driver, comprising:
reducing an operating current of a receiving interface circuit of the source driver to the abnormal operating level in period from the source driver is reset to before the pixel data of the source driver is appeared in the data signal.

3. The operation method of claim 1, wherein reducing the operating current of the source driver, comprising:
reducing an operating current of a frequency divider of the source driver to the abnormal operating level in period from the source driver is reset to before the pixel data of the source driver is appeared in the data signal.

4. The operation method of claim 1, wherein reducing the operating current of the source driver to the abnormal operating level, comprising:
providing a clock signal to the source driver, wherein a clock receiver and at least one data receiver of the source driver receive the clock signal and the data signal, respectively;
reducing an operating current of the clock receiver to the abnormal operating level in period from the source driver is reset to before an initial impulse is generated by an initial signal transmitted to the source driver, so as to maintain synchronizing of the clock signal in the source driver, wherein a timing of the initial impulse is in respond to a timing in which the pixel data of the source driver is appeared in the data signal; and
suspending power supply to the data receiver in period from the source driver is reset to before the initial impulse is generated by the initial signal.

5. The operation method of claim 4, wherein restoring the operating current of the source driver to the normal operating level, comprising:
resuming power supply to the data receiver after the initial impulse is generated by the initial signal.

6. The operation method of claim 1, further comprising:
providing a clock signal to the source driver, wherein a clock receiver of the source driver receives the clock signal, and provides an internal clock corresponding to the clock signal to a core circuit of the source driver through a clock transmission path;
turning off the clock transmission path to stop providing the internal clock to the core circuit in period from the source driver is reset to before the pixel data of the source driver is appeared in the data signal; and
restoring the clock transmission path when the pixel data of the source driver is appeared in the data signal.

7. The operation method of claim 1, wherein reducing the operating current of the source driver to the abnormal operating level, comprising:
providing a clock signal to the source driver, wherein a receiving interface circuit of the source driver receives the clock signal and the data signal, and provides an internal clock corresponding to the clock signal to a core circuit of the source driver through a clock transmission path;
reducing an operating current of the receiving interface circuit to the abnormal operating level, and turning off the clock transmission path, in period from the source driver is reset to before a first initial impulse is generated by an initial signal transmitted to the source driver, wherein a timing of the first initial impulse is in respond to a timing in which the pixel data of the source driver is appeared in the data signal.

8. The operation method of claim 7, further comprising:
restoring the operating current of the receiving interface circuit to the normal operating level, and continuing to turn off the clock transmission path, in period from the first initial impulse is generated by the initial signal to before a second initial impulse is generated by the initial signal; and
maintaining the operating current of the receiving interface circuit to the normal operating level, and restoring the clock transmission path, after the second initial impulse is generated by the initial signal.

9. The operation method of claim 1, further comprising:
reducing the operating current of the source driver to the abnormal operating level again after the pixel data of the source driver appeared in the data signal is transmitted.

10. The operation method of claim 1, further comprising:
starting a time counting after the source driver is reset, so as to determine a timing in which the pixel data of the source driver is appeared in the data signal.

11. A source driver, comprising:
a receiving interface circuit configured to receive a data signal and a clock signal from outside of the source driver and output an internal clock corresponding to the clock signal;
a core circuit coupled to the receiving interface circuit, and configured to drive a display panel outside of the source driver by using a pixel data of the source driver appeared in the data signal according to a timing of the internal clock; and
a current source control circuit coupled to the receiving interface circuit, and configured to supply an operating current to the receiving interface circuit,
wherein the current source control circuit reduces the operating current of the receiving interface circuit to an abnormal operating level in period from the source driver is reset to before the pixel data of the source driver is appeared in the data signal, and
the current control circuit restores the operation current of the receiving interface circuit to a normal operating level when the pixel data of the source driver is appeared in the data signal.

12. The source driver of claim 11, wherein the receiving interface circuit comprises:
a clock receiver configured to receive the clock signal and output the internal clock corresponding to the clock signal to the core circuit; and
at least one data receiver configured to receive the data signal and provide the data signal to the core circuit;
wherein the current source control circuit reduces an operating current of the clock receiver to the abnormal operating level and suspends power supply to the data receiver in period from the source driver is reset to before the pixel data of the source driver is appeared in the data signal, and
wherein the current source control circuit restores the operating current of the clock receiver to the normal operating level and resumes power supply to the data receiver when the pixel data of the source driver is appeared in the data signal.

13. The source driver of claim 12, wherein the clock receiver comprises:
a receiver configured to receive the clock signal; and
a frequency divider coupled to an output terminal of the receiver, and configured to convert an output of the receiver into the internal clock and output the internal clock to the core circuit;
wherein the current source control circuit reduces the operating currents of the receiver and the frequency divider to the abnormal operating level in period from the source driver is reset to before the pixel data of the source driver is appeared in the data signal; and
wherein the current source control circuit restores the operation currents of the receiver and the frequency divider to the normal operating level when the pixel data of the source driver is appeared in the data signal.

14. The source driver of claim 11, wherein the current source control circuit receives an initial signal from outside of the source driver; the current source control circuit reduces the operating current of the receiving interface circuit to the abnormal operating level in period from the source driver is reset to before an initial impulse is generated by the initial signal, wherein a timing of the initial impulse is in response to a timing in which the pixel data of the source driver is appeared in the data signal; and the current source control circuit restores the operating current of the receiving interface circuit to the normal operating level after the initial impulse is generated by the initial signal.

15. The source driver of claim 11, wherein the receiving interface circuit provides the internal clock to the core circuit through a clock transmission path, and the source driver further comprises:
a switch disposed on the clock transmission path, and coupled between the receiving interface circuit and the core circuit,
wherein the switch turns off the clock transmission path to stop providing the internal clock to the core circuit in period from the source driver is reset to before the pixel data of the source driver is appeared in the data signal; and
the switch restores the clock transmission path when the pixel data of the source driver is appeared in the data signal.

16. The source driver of claim 11, wherein the receiving interface circuit provides the internal clock to the core circuit through a clock transmission path, the current source circuit receives an initial signal from outside of the source driver, and the source driver further comprises:
a switch disposed on the clock transmission path, and coupled between the receiving interface circuit and the core circuit,
wherein the current source control circuit reduces the operating current of the receiving interface circuit to the abnormal operating level, and the switch turns off the clock transmission path, in period from the source driver is reset to before a first initial impulse is generated by the initial signal, wherein a timing of the first initial impulse is in respond to a timing in which the pixel data of the source driver is appeared in the data signal;
wherein the current source control circuit restores the operating current of the receiving interface circuit to the normal operating level, and the switch continues to turn off the clock transmission path, in period from the first initial impulse is generated by the initial signal to before a second initial impulse is generated by the initial signal; and wherein the current source control circuit maintains the operating current of the receiving interface circuit to the normal operating level, and the switch restores the clock transmission path, after the second initial impulse is generated by the initial signal.

17. The source driver of claim 11, wherein the current source control circuit reduces the operating current of the source driver again to the abnormal operating level after the pixel data of the source driver appeared in the data signal is transmitted.

18. The source driver of claim 11, further comprising:
a counter coupled to the current source control circuit, and configured to start a time counting after the source driver is reset, and provide a timing result to the current source control circuit, wherein the current source control circuit determines a timing in which the pixel data of the source driver is appeared in the data signal according to the timing result.
